(19) United States
(12) Patent Application Publication
(10) Pub. No.: US 2024/0356263 A1
(43) Pub. Date: Oct. 24, 2024

(54) CONNECTOR

(71) Applicant: Rosenberger Hochfrequenztechnik GmbH & Co. KG, Fridolfing (DE)

(72) Inventors: Ludwig HUBER, Fridolfing (DE); Michael SOMMERAUER, Teisendorf (DE)

(21) Appl. No.: 18/138,167

(22) Filed: Apr. 24, 2023

(51) Int. Cl. H01R 13/424; H01R 12/71; H01R 13/629

(52) U.S. Cl. CPC H01R 13/424; H01R 12/716; H01R 13/629

(57) ABSTRACT

A connector comprising a contact support, and an elastically deformable element, wherein the connector defines a contact direction, and in a deformed state, the elastically deformable element exerts a force that urges the contact support in the contact direction.

### BACKGROUND OF THE DISCLOSURE

### Field of the Disclosure

The present disclosure relates to a connector, in particular to an electrical connector.

### Description of the Related Art

It is known provide an electrical connector with contacts. The present disclosure expounds upon this background.

### SUMMARY OF THE PRESENT DISCLOSURE

The aim of the present summary is to facilitate understanding of the present disclosure. The summary thus presents concepts and features of the present disclosure in a more simplified form and in looser terms than the detailed description below and should not be taken as limiting other portions of the present disclosure.

Loosely speaking, the present disclosure teaches a connector comprising a contact support, and an elastically deformable element, where the elastically deformable element, in a deformed state, exerts a force that urges the contact support in a contact direction defined by the connector. By employing an elastically deformable element to assist in a positioning of the contact support, the connector can accommodate larger positional inaccuracies without necessitating a large range of motion from the connector contacts per se. This allows the use of shorter connector contacts, which allows higher frequency signals to be transmitted via the connector.

Still loosely speaking, the present disclosure furthermore teaches a connector comprising a housing, a contact support, and an elastically deformable element, where the elastically deformable element inhibits a movement of the contact support from a position in which the contact support intersects a reference plane defined by the housing. By employing an elastically deformable element to resist movement of the contact support from the reference plane, the connector can accommodate larger positional inaccuracies without necessitating a large range of motion from the connector contacts per se. This allows the use of shorter connector contacts, which allows higher frequency signals to be transmitted via the connector.

Other objects, advantages and embodiments of the present disclosure will become apparent from the detailed description below, especially when considered in conjunction with the accompanying drawings.

### BRIEF DESCRIPTION OF THE DRAWINGS

The Figures show:

FIGS. 1A and 1B show a first embodiment of a connector in accordance with the present disclosure;

FIG. 2 shows a second embodiment of a connector in accordance with the present disclosure;

FIG. 3 shows a third embodiment of a connector in accordance with the present disclosure;

FIG. 4 shows a fourth embodiment of a connector in accordance with the present disclosure;

FIGS. 5A and 5B show a fifth embodiment of a connector in accordance with the present disclosure;

FIGS. 6A and 6B show a sixth embodiment of a connector in accordance with the present disclosure; and

FIGS. 7A to 7C show a seventh embodiment of a connector in accordance with the present disclosure;

FIGS. 8A and 8B show details of an eighth embodiment of a connector in accordance with the present disclosure.

### DETAILED DESCRIPTION

The various embodiments of the present disclosure and of the claimed invention, in terms of both structure and operation, will be best understood from the following detailed description, especially when considered in conjunction with the accompanying drawings.

Before elucidating the embodiments shown in the Figures, the various embodiments of the present disclosure will first be described in general terms.

The present disclosure teaches a connector, e.g. an electrical connector.

The connector may comprise a (first) plurality of contacts. Similarly, the connector may comprise at least one contact support, e.g. a contact support that supports the (first) plurality of contacts or a plurality of contact supports that individually support a respective subset of the (first) plurality of contacts. Hereinafter, the term “the contact” will be used to designate any of the (first) plurality of contacts. (An elucidation of the term “any” is given in the closing paragraphs of this specification.) The contact may consist (substantially) of an electrically conductive material, e.g. copper. Similarly, at least 70%, at least 80%, or at least 90% of the contact by weight and/or volume may consist of an electrically conductive material. The contact support may comprise an electrically insulating material that (—as regards a portion of the contact embedded in the contact support—) electrically insulates the contact from any other contacts of the (first) plurality of contacts. For example, the contact support may comprise an electrically insulating material that (—as regards a portion of the contact embedded in the contact support—) electrically insulates each individual one of the (first) plurality of contacts from each individual other contact of the (first) plurality of contacts. In the present disclosure, the term “electrically conductive material” may be understood as a material that exhibits a volume resistivity of less than 10⁵ Ω·cm. In the present disclosure, the term “electrically insulating material” may be understood as a material that exhibits a volume resistivity greater than 10⁹ Ω·cm. As regards a portion of the contact not embedded in, e.g. protruding from, the contact support, the contact may be electrically insulated from any other contacts of the (first) plurality of contacts by an air gap. The contact support may consist (substantially) of an electrically insulating material, e.g. a plastic material. Similarly, at least 70%, at least 80%, or at least 90% of the contact support by weight and/or volume may consist of an electrically insulating material. The contact support may comprise an alignment structure. The alignment structure may comprise at least one planar surface, e.g. an outward-facing surface. Similarly, the alignment structure may be an edge of a (n outward-facing) planar surface. the alignment structure may comprise (at least) three bumps. The planar surface/bumps may constitute an outward facing/outermost element of the contact support and/or the connector.

The connector may comprise at least one elastically deformable element. The elastically deformable element may be an elastomeric element, an elastomeric strip, an elastomeric tube, an elastomeric cylinder, an elastomeric block, an elastomeric ellipsoid, a metal strip, a spring, a spiral spring, a disk spring, a plate spring, a leaf spring, a cantilever, a spring arm, or an elastically deformable plate.

The connector may define a contact direction. The elastically deformable element, in a deformed state, may exert a force that (directly or indirectly) urges the contact support in the contact direction. The contact direction may be a direction toward a (closest) exterior of the connector. The contact direction may be a direction from the elastically deformable element toward a distal tip of the contact. Similarly, the contact direction may be a direction from the elastically deformable element toward the alignment structure. Similarly, the contact direction may be a direction from the elastically deformable element toward and perpendicular to an imaginary plane defined by the (first) plurality of contacts and/or the alignment structure. In the context of an minimally sized, imaginary rectangular cuboid that encloses the connector (optionally excepting the at least one signal transmission component described below), the contact direction may be a direction toward and perpendicular to a first side of the imaginary cuboid closest to the (first) plurality of contacts from a second side of the imaginary cuboid opposite the first side. Furthermore, the contact direction may be a direction from the elastically deformable element toward and perpendicular to a reference plane (as disclosed below). The connector may be structured to engage a (connector-receiving) device. The contact direction may be a direction of (shortest) motion of the connector that distinguishes an unengaged state (of the connector) from a (fully) engaged state (of the connector) or that distinguishes a partly engaged state (of the connector) from a fully engaged state.

The connector may comprise a housing. The housing may be a one-piece housing or a multi-piece housing, i.e. a housing comprising at least two housing parts (that collectively constitute the housing). Any two (or more) of the at least two housing parts may be structured (e.g. in terms of shape and/or material) to snappingly engage and/or to fit snuggly. The housing and/or any housing part may be of an electrically conductive material, e.g. tin plate, an electrically insulating material, e.g. plastic, or a conglomeration of at least one electrically conductive material and at least one electrically insulating material.

The connector may comprise at least one clamp. The clamp may be (elastically) affixed to the housing, e.g. via an elastic (affixing) material. The clamp may be of a (non-elastic) rigid material. The clamp may have a shape that allows the clamp to latch to a (connector-receiving) device with a deformation of the clamp, e.g. by a sliding of the clamp relative to the housing. Similarly, the clamp may be of an elastic material. The clamp may have a shape that allows the clamp to be deformed, e.g. relative to the housing. An engagement of the connector and a (connector-receiving) device may effect a deformation of the elastic material. A returning force exerted by the elastic material (in response to a deformation) may act to position and/or retain the connector, e.g. the housing and/or the contact support in particular, in a desired position relative to the (connector-receiving) device. For example, the returning force may act to position and/or retain the alignment structure of the contact support in abutment with an alignment surface (of the (connector-receiving) device), e.g. by contributing to (opposing) forces that effect an elastic deformation of the elastically deformable element. Similarly, the returning force may contribute to forces that effect an elastic deformation of (a distal tip of) the contact and/or a contact force between (a distal tip of) the contact and the alignment surface (of the (connector-receiving) device). A potential energy (stored by the elastic material in response to a deformation) may act to retain the connector to the (connector-receiving) device. For example, the connector, e.g. the clamp in particular, may be structured, e.g. relative to the (connector-receiving) device, such that energy must be invested (by a user) to remove the connector from the (connector-receiving) device. As already touched upon above, the connector, e.g. the clamp in particular, may be structured to (elastically) latch to the (connector-receiving) device. The connector, e.g. the clamp in particular, may comprise a retaining structure, e.g. an opening and/or protrusion. Similarly, the (connector-receiving) device may comprise an associated, e.g. counterpart, retaining structure, e.g. a protrusion and/or opening. The retaining structure of the connector/clamp may be structured to engage, e.g. latch to, the associated retaining structure of the (connector-receiving) device, e.g. in such a fashion that a motion of the clamp relative to the housing and/or the (connector-receiving) device (which motion increases a potential energy stored in the clamp, the elastic affixing material, and/or elsewhere in the connector) is necessary to disengage the clamp (and connector) from the (connector-receiving) device.

The connector may structured such that an engagement of the connector and a (connector-receiving) device effects a deformation of the elastically deformable element. Engagement of the connector and a (connector-receiving) device may effect a motion of any individual contact support in a direction toward an interior of the connector, e.g. on account of an abutting of the individual contact support against the (connector-receiving) device. Motion of any individual contact support in a direction toward an interior of the connector may contribute, e.g. incur a force that contributes, (directly and/or indirectly) to a deformation of the elastically deformable element. Similarly, engagement of the connector and a (connector-receiving) device may urge and/or effect a motion of any other individual contact support in a direction toward an exterior of the connector. For example, engagement of the connector and a (connector-receiving) device may effect a motion (of at least a portion) of the elastically deformable element in a direction, e.g. in the contact direction, that urges any individual contact support in a direction toward an exterior of the connector. The (connector-receiving) device may impede the individual contact support from moving (more than a certain distance) toward an exterior of the connector. An impeding force from the (connector-receiving) device may contribute, e.g. via the contact support, to a deformation of the elastically deformable element. The impeding force may constitute one of at least two opposing forces that effect an elastic deformation of the elastically deformable element.

The elastically deformable element may be affixed to the connector, e.g. to the housing, the clamp, and/or (the first surface of) the contact support. Any individual one of the at least one elastically deformable element may be affixed to the connector independently of any other of the least one elastically deformable element, e.g. such that any individual one of the at least one elastically deformable element may move and/or be deformed independently of any other of the least one elastically deformable element. The elastically deformable element may be situated intermediate (the first surface of) the contact support and a (n interior) surface of the connector, e.g. intermediate (the first surface of) the contact support and a (n interior) surface of the housing. The elastically deformable element may abut (the first surface of) the contact support and a (n interior) surface of the connector, e.g. a (n interior) surface of the housing. The elastically deformable element may extend from a first wall of the housing or clamp to a second (opposite) wall of the housing or clamp. For example, a first end of the elastically deformable element may be mounted to a first wall of the housing or clamp and a second (opposite) end of the elastically deformable element may be mounted to a second (opposite) wall of the housing or clamp. The first and/or second wall may be an outer wall of the housing/clamp. A longitudinal axis of the elastically deformable element may be (less than 10°, or less than 5° from) perpendicular to (an edge of the imaginary rectangular cuboid that defines) a length of the contact. The contact support may comprise a cutout that (matingly) engages a portion of a surface of the elastically deformable element.

The elastically deformable element may abut a first surface of the contact support. The first surface may be situated on a first side of the contact support. The alignment structure may constitute/be situated on a second side of the contact support. The first and second sides may constitute (generally) opposite sides of the contact support. A first force exerted on the alignment structures in a direction of the contact support may yield, e.g. via the first surface abutting the elastically deformable element, a second force that deforms the elastically deformable element.

The contact support may be elastically supported relative to the housing. For example, the contact support may be elastically supported relative to the housing such that the contact support is elastically held in a first position. In the first position, the contact support may abut the elastically deformable element without (substantially) deforming the elastically deformable element. The first position may be a rest position (of the contact support) in which no forces external to the connector are acting (directly or indirectly) on the contact support. The first position may be a position adopted by the contact support in an unengaged state of the connector and a (connector-receiving) device. Further characterizations of the first position are disclosed below.

The connector may comprise at least one signal transmission component. The signal transmission component may be a passive signal transmission component, e.g. a signal transmission component capable of passively transmitting electrical signals at a frequency of less than 200 GHz. The signal transmission component may comprise at least one conductive (signal transmission) element, e.g. at least one wire or trace. The signal transmission component may comprise a shielded signal line, e.g. a shielded conductor. Similarly, the signal transmission component may comprise an unshielded signal line, e.g. an unshielded conductor. The signal transmission component may be a wire, a cable, or a flexible printed circuit board.

The signal transmission component may be an insulated wire. The insulated wire may comprise a (solid or stranded) core of an electrically conductive material, e.g. copper, (an entire circumference of) at least 80%, at least 90%, or at least 95% of an overall length of the core being ensheathed by an electrically insulating material, e.g. a plastic material. In the present disclosure, the term “ensheathed” may be understood in the sense that, for each point along the relevant length of the ensheathed element, an imaginary plane through the respective point perpendicular to a longitudinal axis of the ensheathed element at the respective point intersects a cross-section of the ensheathing element, which cross-section of the ensheathing element defines a closed path (360°) around the ensheathed element.

As already noted above, the signal transmission component may be a flexible printed circuit board. Similarly, the signal transmission component may be a flexible substrate (of an electrically insulating material) comprising at least one conductive trace (of an electrically conductive material).

The signal transmission component may be a twisted-pair cable. The twisted-pair cable may comprise a first insulated wire and a second insulated wire. The first insulated wire may be an insulated wire as described above. The second insulated wire may be an insulated wire as described above. The first and second insulated wires may constitute a twisted pair of the twisted-pair cable. The twisted-pair cable may be a twisted-pair cable capable of transmitting a signal at a frequency in excess of 1 GHz, in excess of 5 GHz, in excess of 10 GHz, or in excess of 50 GHz via the first and second insulated wires.

The signal transmission component may be a coaxial cable, e.g. a coaxial cable comprising a reference conductor, a signal conductor, and an electrically insulating material, e.g. a plastic material, intermediate the signal conductor and the reference conductor. The reference conductor may constitute an outer conductor of the coaxial cable, and the signal conductor may constitute an inner conductor of the coaxial cable. For the sake of simplicity, the signal conductor may be termed a “core”. The signal conductor may be a (solid or stranded) core of an electrically conductive material, e.g. copper, (an entire circumference of) at least 80%, at least 90%, or at least 95% of an overall length of the core being ensheathed by the electrically insulating material. The reference conductor may be of an electrically conductive material, e.g. copper, and may ensheath (an entire circumference of) at least 80%, at least 90%, or at least 95% of an overall length of the electrically insulating material that ensheaths the core. The reference conductor may electromagnetically shield at least 80% or at least 90% of a length of the signal conductor. The coaxial cable may comprise (plastic) sheathing that ensheaths at least 80%, at least 90%, or at least 95% of an overall length of the reference conductor. The coaxial cable may be capable of transmitting a signal at a frequency in excess of 1 GHz, in excess of 5 GHz, in excess of 10 GHz, or in excess of 50 GHz via the signal conductor.

The signal transmission component may be a twin-axial cable, e.g. a twin-axial cable comprising a reference conductor, a first signal conductor, a second signal conductor, and an electrically insulating material, e.g. a plastic material. For the sake of simplicity, the first signal conductor may be termed a “first core”, and the second signal conductor may be termed a “second core”. The reference conductor may constitute an outer conductor of the twin-axial cable, the first signal conductor may constitute a first inner conductor of the twin-axial cable, and the second signal conductor may constitute a second inner conductor of the twin-axial cable. The first and/or second core may be a (solid or stranded) core of an electrically conductive material, e.g. copper. The electrically insulating material may ensheath (an entire circumference of) at least 80%, at least 90%, or at least 95% of an overall length of the first and/or second core (individually). As such, the electrically insulating material may electrically insulate (an ensheathed portion of) the second core from (an ensheathed portion of) the first core. The reference conductor may electromagnetically shield at least 80% or at least 90% of a length of the first and/or second core. The reference conductor may be of an electrically conductive material, e.g. copper, and may ensheath and/or form a single tube that ensheaths (an entire collective circumference of) at least 80%, at least 90%, or at least 95% of an overall length of the electrically insulating material that ensheaths the first and/or second core. As such, the electrically insulating material may electrically insulate the reference conductor from (an ensheathed portion of) the second core and/or from (an ensheathed portion of) the first core. The twin-axial cable may comprise (plastic) sheathing that ensheaths at least 80%, at least 90%, or at least 95% of an overall length of the reference conductor. The twin-axial cable may be capable of transmitting a signal at a frequency in excess of 1 GHz, in excess of 5 GHz, in excess of 10 GHz, or in excess of 50 GHz via the first and second signal conductors.

The signal transmission component may be affixed to the housing, e.g. such that the (first/second) core of the signal transmission component is electrically insulated from the housing or such that each conductive trace of the signal transmission component is electrically insulated from the housing. The signal transmission component may elastically support the contact support (relative to the housing). For example, a first portion of the signal transmission component may be rigidly affixed to the housing and a second portion of the signal transmission component may be (rigidly) affixed to the contact support, an intermediate portion of the signal transmission component intermediate the first and second portion acting as a spring. Similarly, a first portion of the signal transmission component may be elastically affixed to the housing, e.g. by means of an elastic material such as rubber, silicone rubber, or a (thermoplastic) elastomer, and a second portion of the signal transmission component may be (rigidly) affixed to the contact support, an intermediate portion of the signal transmission component intermediate the first and second portion being rigid or acting as a spring. In an unengaged state of the connector, the signal transmission component may elastically support the contact support in the first position. Similarly, the signal transmission component may elastically support the contact support such that the contact support abuts the elastically deformable element without (substantially) deforming the elastically deformable element in an unengaged state of the connector.

The contact may be an elongate contact. A length of the contact may be at least 5 times, at least 10 times, or at least 15 times a width of the contact. The width of the contact may be at least 2 times, at least 5 times, or at least 10 times a thickness of the contact. Similarly, the width of the contact may be at least 0.25 times, at least 0.5 times, or at least 1.0 times a thickness of the contact (and less than 0.5 times, less than 1.0 times, less than 2 times, or less than 5 times a thickness of the contact. The length of the contact may be a length of a longest edge of a minimally sized, imaginary rectangular cuboid that encloses the contact. Similarly, the length of the contact may be a length of an edge of the imaginary rectangular cuboid, which edge is (most closely) parallel to a (primary) direction of signal propagation through the contact. Similarly, the length of the contact may be a length of an edge of the imaginary rectangular cuboid, which edge is (most closely) parallel to an imaginary line from a first portion of the contact that contacts, e.g. by welding or soldering, a conductor to a second portion of the contact most distal from the first portion. The thickness of the contact may be a length of a shortest edge of the imaginary rectangular cuboid. Similarly, the thickness of the contact may be a length of an edge of the imaginary rectangular cuboid (closest to) perpendicular to a plane that intersects each of the (first) plurality of contacts, e.g. a plane of a common layer (as described below). The width of the contact may be a length of an edge of the imaginary rectangular cuboid that is perpendicular to the edge that defines a length of the contact and perpendicular to the edge that defines the thickness. The contact may have a shape of a rectangular cuboid. The contact may have a shape that fills at least 80%, at least 90%, or at least 95% of the imaginary rectangular cuboid. The length of the contact may be less than 20 mm, less than 15 mm, less than 10 mm, less than 5 mm, or less than 2 mm. The width of the contact may be less than 1 mm, less than 0.5 mm, less than 0.2 mm, or less than 0.1 mm. The thickness of the contact may be less than 1 mm, less than 0.5 mm, less than 0.2 mm, or less than 0.1 mm. The teachings of this paragraph apply to the contact in an unbent state without being limited to an unbent state.

As touched upon above, the connector may comprise a (first) plurality of contacts. The (first) plurality of contacts may comprise at least 10, at least 20, or at least 40 contacts. Similarly, the (first) plurality of contacts may comprise not more than 100, not more than 50, or not more than 20 contacts. The (first) plurality of contacts may comprise a first contact, a second contact, and a third contact. The second contact may be situated intermediate the first contact and the third contact. For example, the second contact may be situated such that at least one imaginary straight line exists from the first contact to the third contact that intersects the second contact. Similarly, the second contact may be situated such that every imaginary straight line from the first contact to the third contact intersects the second contact. The (first) plurality of contacts may comprise a fourth contact. The fourth contact may be situated intermediate the first contact and the third contact. For example, the fourth contact may be situated such that at least one imaginary straight line exists from the first contact to the third contact that intersects the fourth contact. Similarly, the fourth contact may be situated such that every imaginary straight line from the first contact to the third contact intersects the fourth contact. As touched upon above, each of the first contact, the second contact, the third contact, and the fourth contact may be electrically insulated from each other of the first contact, the second contact, the third contact, and the fourth contact, e.g. by an air gap and/or an electrically insulating material (interposed between the respective contacts). Similarly, the second contact and the fourth contact may be electrically insulated from each other of the first contact, the second contact, the third contact, and the fourth contact, e.g. by an air gap and/or an electrically insulating material (interposed between the respective contacts), while the first contact and the third contact are electrically connected, e.g. by the reference conductor. The air gap may be an air gap of at least 0.01 mm, at least 0.02 mm, at least 0.05 mm, or at least 0.1 mm.

Any individual core and/or any individual conductive trace of the at least one signal transmission component may electrically contact, e.g. be (directly) welded or soldered to, an individual one of the (first) plurality of contacts, e.g. at a location inside the contact support. Similarly, the reference conductor of any of the at least one signal transmission component may electrically contact, e.g. be (directly) welded or soldered to, at least one of the (first) plurality of contacts, e.g. at a location inside the contact support or at a location outside, proximate to, and/or adjacent to, the contact support. For example, the reference conductor (of one signal transmission component) may electrically contact the first contact and/or the third contact. The signal conductor (of the one signal transmission component) may electrically contact the second contact and/or the fourth contact. The (first) signal conductor (of the one signal transmission component) may electrically contact the second contact. The (second) signal conductor (of the one signal transmission component) may electrically contact the fourth contact.

The (first) plurality of contacts may be provided at a pitch of less than 5 mm, less than 2 mm, less than 1 mm, less than 0.5 mm, less than 0.2 mm, less than 0.1 mm, less than 0.05 mm, or less than 0.02 mm. A distance from the first contact to the second contact may be less than 5 mm, less than 2 mm, less than 1 mm, less than 0.5 mm, less than 0.2 mm, less than 0.1 mm, less than 0.05 mm, or less than 0.02 mm. The distance may be a (minimal) distance from a central longitudinal axis of a minimally sized imaginary rectangular cuboid enclosing the first contact to a central longitudinal axis of a minimally sized imaginary rectangular cuboid enclosing the second contact.

As noted above, the (first/second/third/fourth) contact may protrude from the contact support, e.g. (in a direction and with a length) such that, e.g. in an unengaged state of the connector and a (connector-receiving) device, (a distal tip of) the contact intersects or is tangent to the (imaginary) plane defined by the alignment structure. Similarly, the contact may protrude from the contact support (in a direction and with a length) such that, e.g. in an engaged state of the connector and a (connector-receiving) device, (a distal tip of) the contact abuts the alignment surface (of the (connector-receiving) device). The contact may protrude from the contact support such that, e.g. in an engaged state of the connector and a (connector-receiving) device, (a distal tip of) the contact is elastically deformed (relative to an unengaged state) and/or (as a result of the elastic deformation) exerts a contact force against the alignment surface (of the (connector-receiving) device). A portion of the (first/second/third/fourth) contact may protrude from the contact support, e.g. by (a protruding length of) less than 5 mm, less than 2 mm, less than 1 mm, or less than 0.5 mm. The protruding length may be parallel to a length of the contact, e.g. parallel to the longest edge of a minimally sized, imaginary rectangular cuboid that encloses the (respective, individual) contact.

The at least one signal transmission component may be grouped into one, two, three, four, or more sets of signal transmission components. The at least one signal transmission component may be grouped such that the contacts (welded or soldered to respective cores/conductors/traces of the respective signal transmission components or otherwise in electrical contact therewith) are (correspondingly) grouped into one, two, three, four, or more parallel sets of parallel contacts, i.e. into one, two, three, four, or more parallel rows of contacts. A distance from a distal tip of a contact belonging to one set/row to a distal tip of a contact belonging to another set/row may be at least 10, or at least 20 times a pitch of contacts belonging to the one or the other set/row. Similarly, a distance from a distal tip of a contact belonging to one set/row to a distal tip of a contact belonging to another set/row may be at least 10, or at least 20 times a (minimal) distance from a central longitudinal axis of a minimally sized imaginary rectangular cuboid enclosing a contact of the one set/row to a central longitudinal axis of a minimally sized imaginary rectangular cuboid enclosing a neighboring contact of the one set/row. Any individual contact support may support one, two, three, four, or more parallel rows of contacts. For example, e.g. in a connector comprising four parallel rows of contacts, a first (individual) contact support may support two parallel rows of contacts, and a second (individual) contact support may support another two parallel rows of contacts. Similarly, e.g. in a connector comprising two parallel rows of contacts, a first (individual) contact support may support one row of parallel contacts, and a second (individual) contact support may support another row of parallel contacts. Likewise, e.g. in a connector comprising four parallel rows of contacts, a (single) contact support may support (all) four parallel rows of contacts.

Any of the at least one signal transmission component may be bound together in parallel and/or (generally) planar arrangement, e.g. by a cable clip. For example, for any individual set/row of the sets/rows of signal transmission components, the signal transmission components belonging to the (respective) individual set/row may be bound together in parallel and/or (generally) planar arrangement, e.g. by a cable clip. The bound-together signal transmission components may be affixed to the housing at a location of the cable clip. The cable clip may be of an electrically conductive material, e.g. copper. The cable clip may be bonded to the bound-together signal transmission components by a thermoplastic. The cable clip may comprise a plurality of voids. The thermoplastic may fill any of the plurality of voids.

The connector may comprise at least one (plate-shaped or strip-shaped) stiffener, e.g. a metal stiffener. For example, the connector may comprise a respective stiffener for any individual set/row of bound-together signal transmission components. The stiffener may be affixed, e.g. soldered, to any of the at least one signal transmission component. For example, the stiffener may be affixed to (any individual one of) the bound-together signal transmission components. A longitudinal axis of the stiffener may be (less than 20°, less than 10°, or less than 5° from) perpendicular to a longitudinal axis of an individual signal transmission component affixed to the stiffener. Similarly, a longitudinal axis of the stiffener may be (less than 20°, less than 10°, or less than 5° from) perpendicular to (an edge of the imaginary rectangular cuboid that defines) a length of the contact. A (minimum) thickness of the stiffener, e.g. in a direction perpendicular to a major surface of the stiffener, may be greater than, at least 2 times, at least 3 times, or at least 4 times a thickness of the contact.

The housing may comprise at least one first guide structure. The housing may be structured to (matingly) engage a known device. The (connector-receiving) device may comprise at least one first counterpart guide structure. The first guide structure may serve (together with the first counterpart guide structure) to provide a first degree of alignment between the housing and a (connector-receiving) device (in one, two, or three dimensions), e.g. in a (fully) engaged state of the connector and the (connector-receiving) device. The first guide structure and/or the first counterpart guide structure may comprise at least one taper that delimits an engagement motion of the housing relative to a (connector-receiving) device, e.g. that restricts the engagement motion to an increasingly narrower range as the degree of engagement (engaged state versus non-engaged state) increases.

The connector may comprise at least one second guide structure. The second guide structure may be a constituent element of the contact support. Similarly, the second guide structure may be (rigidly) affixed to the contact support. The (connector-receiving) device may comprise at least one second counterpart guide structure. The second guide structure may serve (together with the second counterpart guide structure) to provide a second degree of alignment between the second guide structure and a (connector-receiving) device (in one, two, or three dimensions), e.g. in a (fully) engaged state of the connector and the (connector-receiving) device. The second degree of alignment may be a more accurate degree of alignment than the first degree of alignment. For example, the second degree of alignment may delimit a range of motion of the second guide structure relative to the (connector-receiving) device (in one, two, or three individual dimensions, e.g. in a direction (less than 20°, less than 10°, or less than 5° from) perpendicular to (an edge of the imaginary rectangular cuboid that defines) a length of the contact) to not more than 70%, not more than 50%, not more than 20%, or not more than 10% of a range of motion of the second guide structure relative to the (connector-receiving) device (in the respective dimension) defined by the first degree of alignment. The second degree of alignment may delimit a range of motion of the second guide structure relative to the (connector-receiving) device (in one, two, or three individual dimensions, e.g. in a direction (less than 20°, less than 10°, or less than 5° from) perpendicular to (an edge of the imaginary rectangular cuboid that defines) a length of the contact) to not more than 0.2 mm, not more than 0.1 mm, not more than 0.05 mm, not more than 0.02 mm, not more than 0.01 mm, or not more than 0.005 mm. The second guide structure and/or the second counterpart guide structure may comprise at least one taper that delimits an engagement motion of the second guide structure relative to a (connector-receiving) device, e.g. that restricts the engagement motion to an increasingly narrower range as the degree of engagement (engaged state versus non-engaged state) increases.

The connector may define a reference plane For example, the housing may define the reference plane. The reference plane may be coplanar with an alignment surface that abuts (and positions) the contact support in a use scenario, e.g. in an engaged state of the connector and a (connector-receiving) device. For example, the reference plane may be coplanar with an alignment surface that abuts the alignment structure of the contact support (in an engaged state of the connector and a (connector-receiving) device). As already touched upon above, the alignment surface may be a surface of a (connector-receiving) device distinct from the connector. The connector may be structured to usefully connect to a known device, the housing and/or clamp engaging the device such that the alignment surface (of the engaged device) is at a specific position relative to the housing and/or clamp. The reference plane may be (offset and) parallel to or coplanar with at least one (outward facing/outermost) planar surface of the housing. Similarly, the reference plane may be (offset and) parallel to or coplanar with a plane defined by (at least) three (outward facing/outermost) points of the housing. The reference plane need not coincide with a surface or other element of the housing.

The first position may be a position in which the contact support does not intersect the reference plane and/or is situated not more than 500 μm, not more than 200 μm, not more than 100 μm, not more than 50 μm, or not more than 20 μm from the reference plane. In the first position, a (minimum) distance from the contact support to the reference plane may be not more than 500 μm, not more than 200 μm, not more than 100 μm, not more than 50 μm, or not more than 20 μm. Alternatively, the first position may be a position in which the contact support does intersect the reference plane. In the first position, the contact support may intersect the reference plane such that a portion of the contact support extends across and beyond (each side of) the reference plane by at least 20 μm, at least 50 μm, at least 100 μm, at least 200 μm, or at least 500 μm. In the first position, as already noted above, the contact support may abut the elastically deformable element without (substantially) deforming the elastically deformable element.

The elastically deformable element may inhibit a movement of the contact support (in at least one direction) from the first position. For example, the elastically deformable element may be situated such that a movement of the contact support from the first position (in at least one direction) (is inhibited because such movement) elastically deforms the elastically deformable element. In particular, the elastically deformable element may inhibit a movement of the contact support, from the first position, toward a (central) interior of the housing and/or in a direction (less than 15°, less than 10°, or less than 5° from) perpendicular to the reference plane. A movement of the contact support (from the first position) into a second position, e.g. into a second position more distant from a (closest) exterior of the housing than the first position, may effect an elastic deformation of the elastically deformable element. Similarly, the elastically deformable element may inhibit a movement of the contact support from the first position to the second position. A minimum distance from the contact support in the second position to an exterior of the housing may be greater than a minimum distance from the contact support in the first position to an exterior of the housing. The second position may be a position adopted by the contact support in an engaged state of the connector and a (connector-receiving) device. Similarly, the second position may be a position in which the alignment structure is aligned with the reference plane and/or abuts the alignment surface (of a (connector-receiving) device). The alignment structure may be aligned with the reference plane in the sense that a (n imaginary) plane defined by the alignment structure is coplanar with the reference plane. The (imaginary) plane may be coplanar to a planar surface of the alignment structure and/or tangent to ((at least three points on) a surface of) the alignment structure. For example, the alignment structure may be aligned with the reference plane in the sense that a planar surface of the alignment structure is coplanar with the reference plane. Similarly, the alignment structure may be aligned with the reference plane in the sense that an edge of a planar surface of the alignment structure is coplanar with the reference plane. The alignment structure may be aligned with the reference plane in the sense that the reference plane is tangent to ((at least three points on) a surface of) the alignment structure, e.g. to (a surface of) the (at least) three bumps. The first/second position may be a position of the contact support relative to the housing. In the present disclosure, a movement of the contact support relative to the housing, e.g. relative to the first/second position, may involve a movement of the contact support relative to the housing and/or a movement of the housing relative to the contact support.

The present disclosure teaches an assembly. The assembly may comprise a connector, e.g. an (electrical) connector as described above. Similarly, the assembly may comprise a device, e.g. a (connector-receiving) device as described above.

The device may comprise a printed circuit board (PCB), an integrated circuit (IC), and/or a package. The device may be encapsulated in a package. The device may comprise a planar surface, e.g. a surface of the printed circuit board, a surface of a die of the integrated circuit, or a surface of a package substrate of the package. The planar surface may constitute the alignment surface. The planar surface may comprise a contact region.

The (connector-receiving) device may comprise a socket. The socket may (be structured to) (matingly) engage a portion of the housing, e.g. to (matingly) engage the at least one first guide structure. The socket may be mounted on a surface of the printed circuit board (PCB), the integrated circuit (IC), or the package. Similarly, the socket may constitute part of and/or be formed in a surface of the printed circuit board (PCB), the integrated circuit (IC), or the package. The housing may engage the socket such that the alignment surface (of the (connector-receiving) device) is at a specific position relative to the housing, e.g. coplanar with the reference plane.

The device may comprise a second plurality of (electrically conductive) contacts, e.g. a plurality of contacts in planar arrangement on a surface. For example, the second plurality of contacts may consist of a plurality of contact pads and/or (signal, clock, and/or ground) traces situated on a surface of a printed circuit board (PCB), on a surface of a die of an integrated circuit, or on a surface of a package substrate. The second plurality of contacts may be situated in and/or constitute the contact region.

The housing (of the connector) may abut the planar surface (of the device), e.g. in an engaged state of the connector and the device, such that the reference plane is coplanar with the planar surface and/or such that the alignment structure of the contact support abuts the planar surface. Similarly, the assembly may be structured such that, e.g. in an engaged state of the connector and the device, the housing (of the connector) abuts a structure of the device such that the reference plane is coplanar with the planar surface and/or such that the alignment structure of the contact support abuts the planar surface.

The first contact may abut the contact region, e.g. in an engaged state of the connector and the device. Similarly, the assembly may be structured such that, e.g. in an engaged state of the connector and the device, each individual contact of the first plurality of contacts respectively contacts one individual contact of the second plurality of contacts. As already touched upon above, the elastically deformable element, e.g. in an engaged state of the connector and the device, may (directly or indirectly) exert a force on the contact support in the contact direction. The connector may be structured such that a force on the contact support in the contact direction acts on the contact, elastically deforming (a distal tip of) the contact against the contact region and/or increasing (as a result of the elastic deformation) a contact force between the contact and the contact region.

The assembly may comprise a component that abuts the connector, e.g. in a manner that presses the connector toward the device. More generally, the component may be arranged to apply a force to the connector that urges (a housing of) the connector toward (a socket mounted on) the device. The force may (act to) retain the housing and socket in a fully engaged state. The component may be fastened to the device, e.g. by screws or glue. Similarly, the component may have a mass of at least 50 g, at least 100 g, or at least 200 g. For example, the component may be a battery, a fan, a transformer, or a heat sink, e.g. a heat sink having a cooling surface that abuts a surface of the device.

The various embodiments of the present disclosure having been described above in general terms, the embodiments shown in the Figures will now be elucidated.

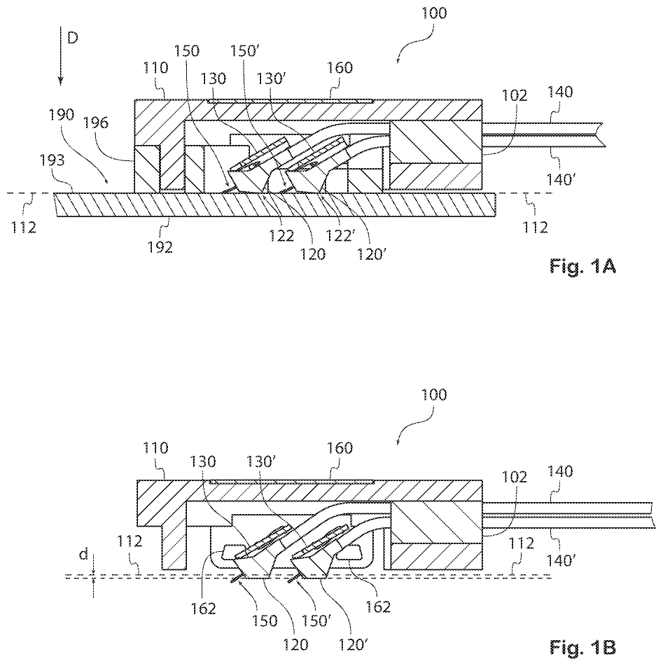

FIGS. 1A and 1B show, in schematic representation, a first embodiment of a connector 100 in accordance with the present disclosure, e.g. as described above.

In the embodiment illustrated in FIGS. 1A and 1B, connector 100 is engaged with a device 190 and comprises an elastic material 102, a housing 110, two contact supports 120, 120′, two elastically deformable elements 130, 130′, two sets of signal transmission components 140, 140′, a plurality of contacts 150, 150′, and a clamp 160. Connector 100 defines a contact direction D. Each of elastically deformable elements 130, 130′ has the form of a metal strip. Device 190 comprises a printed circuit board 192 having a surface 193. Device 190 comprises a socket 196, mounted on surface 193, that matingly engages a portion of housing 110. Elastic material 102 elastically supports contact supports 120, 120′ via signal transmission components 140, 140′ relative to housing 110. Housing 110 defines a reference plane 112 that, in a fully engaged state of housing 110 and socket 196, is coplanar with surface 193. As reflected in FIGS. 1A and 1B, reference plane 112 need not coincide with a surface or other element of housing 110. Contact supports 120, 120′ each comprise a respective alignment structure 122, 122′ that abuts surface 193 of printed circuit board 192, which surface 193 acts as an alignment surface of device 190. Engagement of connector 100 and device 190 effects a deformation of elastically deformable elements 130, 130′ as contact supports 120, 120′ move to the second position shown in FIG. 1A. The deformation of elastically deformable elements 130, 130′ urges contact supports 120, 120′ in contact direction D.

FIG. 1B shows connector 100 of FIG. 1A in an unengaged state. A return force of elastically deformable elements 130, 130′ returns contact supports 120, 120′ to a first position in which contact supports 120, 120′ intersect reference plane 112, contact supports extending across and beyond reference plane 112 by a distance d of at least 20 μm.

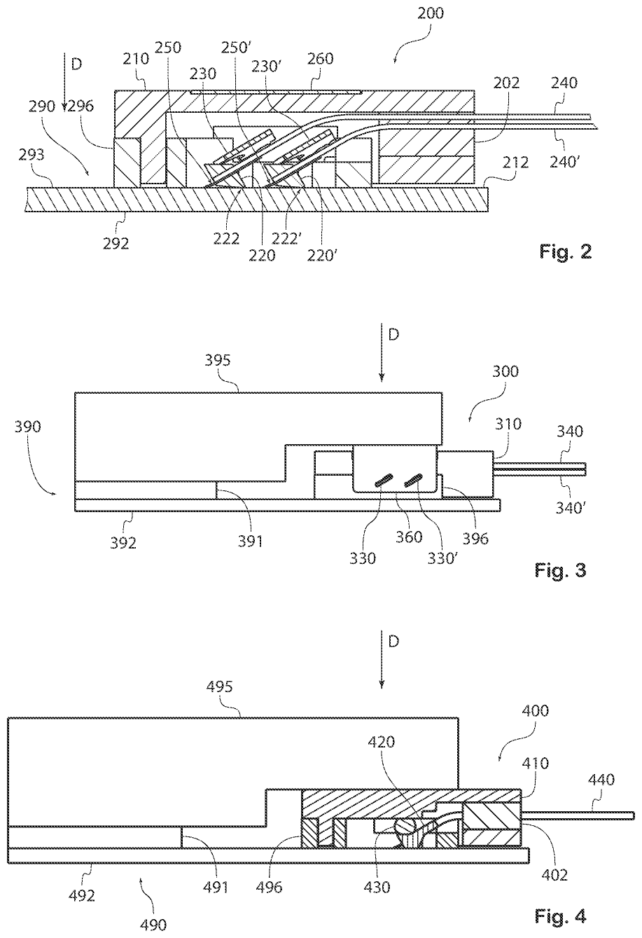

FIG. 2 shows, in schematic representation, a second embodiment of a connector 200 in accordance with the present disclosure, e.g. as described above.

In the embodiment illustrated in FIG. 2, connector 200 is engaged with a device 290 and comprises an elastic material 202, a housing 210, two contact supports 220, 220′, two elastically deformable elements 230, 230′, two sets of signal transmission components 240, 240′, a plurality of contacts 250, 250′, and a clamp 260. Connector 200 defines a contact direction D. Each of elastically deformable elements 230, 230′ has the form of a metal strip, and signal transmission components 240, 240′ are formed as traces on a flexible substrate. Device 290 comprises a printed circuit board 292 having a surface 293. Device 290 comprises a socket 296, mounted on surface 293, that matingly engages a portion of housing 210. Elastic material 202 elastically supports contact supports 220, 220′ via signal transmission components 240, 240′ relative to housing 210. Housing 210 defines a reference plane 212 that, in a fully engaged state of housing 210 and socket 296, is coplanar with surface 293. Contact supports 220, 220′ each comprise a respective alignment structure 222, 222′ that abuts surface 293 of printed circuit board 292, which surface 293 acts as an alignment surface of device 290. Engagement of connector 200 and device 290 effects a deformation of elastically deformable elements 230, 230′, which deformation urges contact supports 220, 220′ in contact direction D, thus bending contacts 250, 250′ and increasing a contact force between contacts 250, 250′ and surface 293.

FIG. 3 shows, in schematic representation, a third embodiment of a connector 300 in accordance with the present disclosure, e.g. as described above.

In the embodiment illustrated in FIG. 3, connector 300 is engaged with a device 390 and is shown as comprising a housing 310, two elastically deformable elements 330, 330′, two sets of signal transmission components 340, 340′, and a clamp 360. Connector 300 defines a contact direction D. Device 390 comprises an integrated circuit 391, a printed circuit board 392, a heat sink 395, and a socket 396. Integrated circuit 391 and socket 396 are mounted on a surface of printed circuit board 392. Socket 396 matingly engages housing 310. Heat sink 395 is mounted on a surface of integrated circuit 391 and presses clamp 360 in a direction of housing 310 and socket 396. The pressing of clamp 360 in a direction of housing 310 and socket 396 presses elastically deformable elements 330, 330′ against respective contact supports (not visible) in an interior of housing 310, deforming elastically deformable elements 330, 330′ such that elastically deformable elements 330, 330′ urge the contact supports in contact direction D.

FIG. 4 shows, in schematic representation, a fourth embodiment of a connector 400 in accordance with the present disclosure, e.g. as described above.

In the embodiment illustrated in FIG. 4, connector 400 is engaged with a device 490 and is shown—in cross-section—as comprising an elastic material 402, a housing 410, a contact support 420, an elastically deformable element 430, and a signal transmission component 440. Elastic material 402 elastically supports contact support 420 via signal transmission component 440 relative to housing 410. Elastically deformable element 430 comprises a solid elastomeric cylinder that is abuttingly situated between an interior surface of housing 410 and contact support 420. Connector 400 defines a contact direction D. Device 490 comprises an integrated circuit 491, a printed circuit board 492, a heat sink 495, and a socket 496. Integrated circuit 491 and socket 496 are mounted on a surface of printed circuit board 492. Socket 496 matingly engages housing 410. Heat sink 495 is mounted on a surface of integrated circuit 491 and presses housing 410 in a direction of socket 496. The pressing of housing 410 in a direction of socket 496 presses elastically deformable element 430 against respective contact support 420, deforming elastically deformable element 430 such that elastically deformable element 430 urges the contact supports in contact direction D.

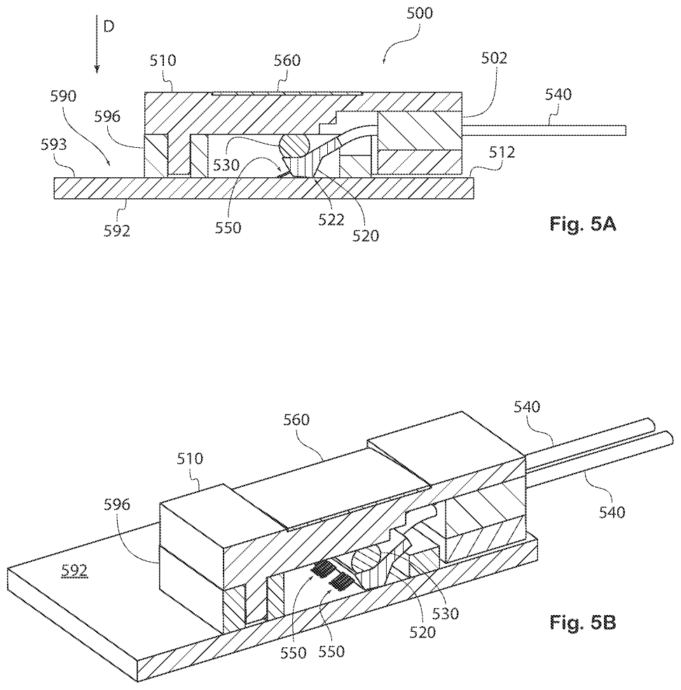

FIGS. 5A and 5B show, in schematic representation, a fifth embodiment of a connector 500 in accordance with the present disclosure, e.g. as described above.

In the embodiment illustrated in FIGS. 5A and 5B, connector 500 is engaged with a device 590 and comprises an elastic material 502, a housing 510, a contact support 520, an elastically deformable element 530, signal transmission components 540, a plurality of contacts 550, and a clamp 560. Elastically deformable element 530 comprises a solid elastomeric cylinder that is abuttingly situated between an interior surface of housing 510 and contact support 420. Connector 500 defines a contact direction D. Device 590 comprises a printed circuit board 592 comprising a surface 593. Device 590 comprises a socket 596, mounted on surface 593, that matingly engages a portion of housing 510. Elastic material 502 elastically supports contact supports 520 via signal transmission components 540 relative to housing 510. Housing 510 defines a reference plane 512 that, in a fully engaged state of housing 510 and socket 596, is coplanar with surface 593. Contact support 520 abuts surface 593 of printed circuit board 592, which surface 593 acts as an alignment surface of device 590. As reflected in FIGS. 5A and 5B, engagement of connector 500 and device 590 effects a deformation of elastically deformable element 530, which deformation urges contact support 520 in contact direction D, thus bending contacts 550 and increasing a contact force between contacts 550 and surface 593.

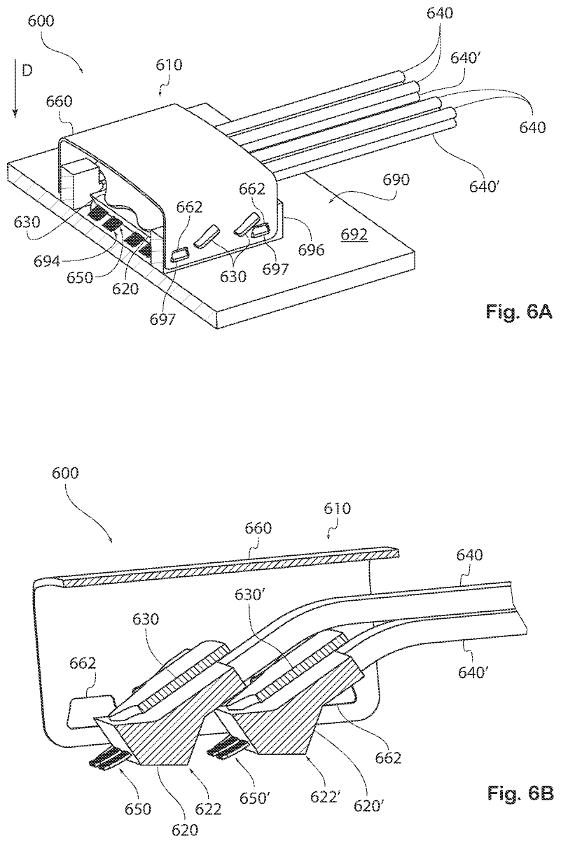

FIGS. 6A and 6B show, in schematic representation, a sixth embodiment of a connector 600 in accordance with the present disclosure, e.g. as described above.

In the embodiment illustrated in FIGS. 6A and 6B, connector 600 is engaged with a device 690 and comprises two contact supports 620, 620′, two elastically deformable elements 630. 630′, two sets of signal transmission components 640, 640′, a plurality of contacts 650, 650′, and a clamp 660. Connector 600 defines a contact direction D. Each of elastically deformable elements 630, 630′ has the form of a metal strip that extends through and is supported by opposite walls of clamp 660. Device 690 comprises a printed circuit board 692 comprising a contact region 694. Device 690 comprises a socket 696 mounted on an upper surface of printed circuit board 692. A housing (not shown) of connector 600 defines a reference plane that, in a fully engaged state of the housing and socket 696, is coplanar with the upper surface of printed circuit board 692. Each of contact supports 620, 620′ comprises an alignment structure 622, 622′ that abuts the upper surface of printed circuit board 692, which upper surface acts as an alignment surface of device 690. Engagement of connector 600 and device 690 effects a deformation of elastically deformable element 630, 630′, which deformation urges contact support 620, 620′ in contact direction D.

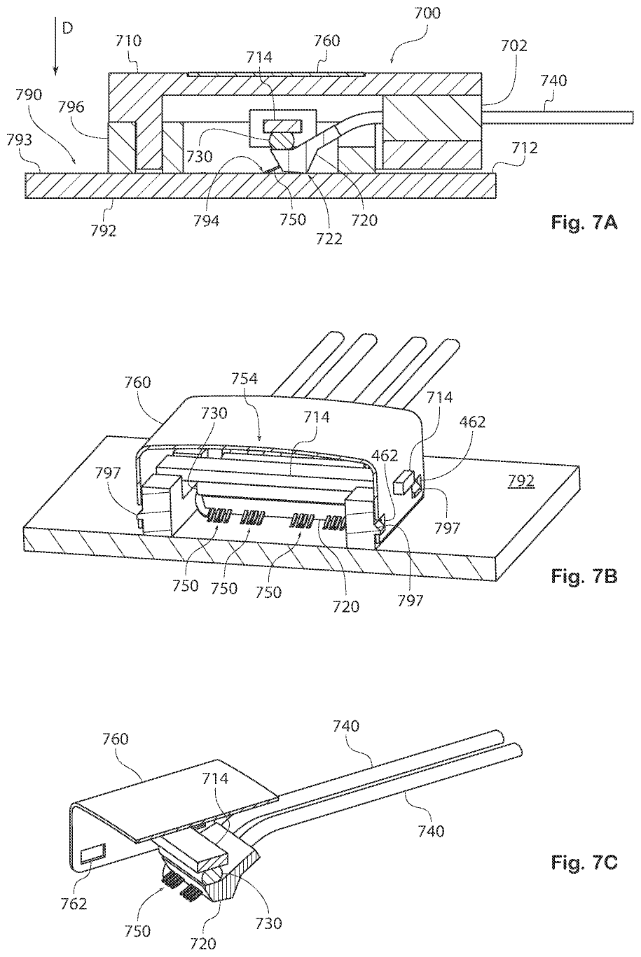

FIGS. 7A to 7C show, in schematic representation, a seventh embodiment of a connector 700 in accordance with the present disclosure, e.g. as described above.

In the embodiment illustrated in FIGS. 7A to 7C, connector 700 is engaged with a device 790 and comprises an elastic material 702, a housing 710, a support structure 714, a contact support 720, an elastically deformable element 730, signal transmission components 740, a plurality of contacts 750, and a clamp 760. Connector 700 defines a contact direction D. Support structure 714 provides an interior surface against which elastically deformable element 730 abuts. Elastically deformable element 730 comprises a solid elastomeric cylinder that is abuttingly situated between support structure 714 and contact support 720. Device 790 comprises a printed circuit board 792 comprising a surface 793 and a contact region 794 on surface 793. Device 790 comprises a socket 796, mounted on surface 793, that matingly engages a portion of housing 710. Elastic material 702 elastically supports contact support 720 via signal transmission components 740 relative to housing 710. Housing 710 defines a reference plane 712 that, in a fully engaged state of housing 710 and socket 796, is coplanar with surface 793. Contact support 720 comprises an alignment structure 722 that abuts surface 793 of printed circuit board 792, which surface 793 acts as an alignment surface of device 790.

As shown in FIG. 78, support structure 714 extends through and is supported by opposite walls of clamp 760. Clamp 760 comprises retaining structures 762 that engage counterpart retaining structures 797 of socket 796.

As reflected in FIGS. 7A to 7C, engagement of connector 700 and device 790 effects a deformation of elastically deformable element 730, which deformation urges contact support 720 in contact direction D. Specifically, when housing 710 fully engages socket 796 and contact support 720—together with contacts 750—abuts printed circuit board 792, a (further) bending of clamp 760 (as reflected by curvature 754 in FIG. 78) to engage counterpart retaining structures 797 forces support structure 714 toward printed circuit board 792, pinching elastically deformable element 930 between support structure 714 and contact support 720.

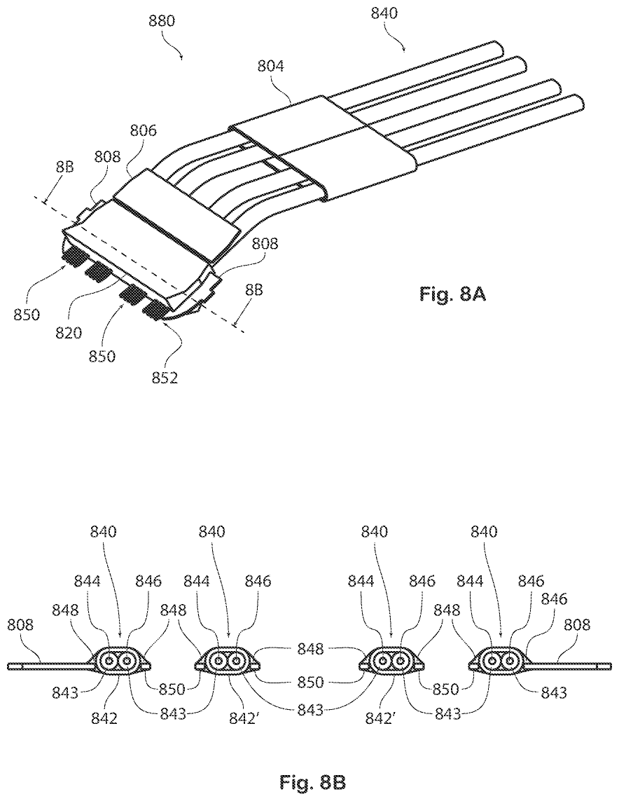

FIGS. 8A and 8B show, in schematic representation, details of an eighth embodiment of a connector in accordance with the present disclosure, e.g. as described above.

More specifically, FIG. 8A shows an assemblage 880 comprising a contact support 820, a plurality of contacts 850, and a plurality of signal transmission components 840 as can be used, inter alia, in the embodiments of FIGS. 1, 5, 6, and 7. In addition to contact support 820, contacts 850, and signal transmission components 840, assemblage 880 comprises a cable clip 804 bonded to signal transmission components 840 by a thermoplastic, a stiffener 806, and two guides 808. Contacts 850 are arranged in a row 852 of parallel contacts.

FIG. 8B schematically depicts a simplified cross-section along line 88 in FIG. 8A. As depicted in FIG. 88, each of signal transmission components 840 is a twin-axial cable that comprises a first signal conductor 844, a second signal conductor 846, a reference conductor 842, 842′ that shields signal conductors 844, 846, and insulation 843 that insulates signal conductors 844, 846 from each other and from reference conductor 842. Two reference conductors 842 are soldered by solder 848 to a respective guide 808 and to a respective contact 850. Two other reference conductors 842′ are soldered by solder 848 to a respective guide 808 and to a respective contact 850.

In the present disclosure, the verb “may” is used to designate optionality/noncompulsoriness. In other words, something that “may” can, but need not. In the present disclosure, the verb “comprise” may be understood in the sense of including. Accordingly, the verb “comprise” does not exclude the presence of other elements/actions. In the present disclosure, relational terms such as “first,” “second,” “top,” “bottom” and the like may be used solely to distinguish one entity or action from another entity or action without necessarily requiring or implying any actual such relationship or order between such entities or actions.

In the present disclosure, the term “any” may be understood as designating any number of the respective elements, e.g. as designating one, at least one, at least two, each or all of the respective elements. Similarly, the term “any” may be understood as designating any collection(s) of the respective elements, e.g. as designating one or more collections of the respective elements, wherein a (respective) collection may comprise one, at least one, at least two, each or all of the respective elements. The respective collections need not comprise the same number of elements.

In the present disclosure, the expression “at least one” is used to designate any (integer) number or range of (integer) numbers (that is technically reasonable in the given context). As such, the expression “at least one” may, inter alia, be understood as one, two, three, four, five, ten, fifteen, twenty or one hundred. Similarly, the expression “at least one” may, inter alia, be understood as “one or more,” “two or more” or “five or more.”

In the present disclosure, expressions in parentheses may be understood as being optional. As used in the present disclosure, quotation marks may emphasize that the expression in quotation marks may also be understood in a figurative sense. As used in the present disclosure, quotation marks may identify a particular expression under discussion.

In the present disclosure, many features are described as being optional, e.g. through the use of the verb “may” or the use of parentheses. For the sake of brevity and legibility, the present disclosure does not explicitly recite each and every combination and/or permutation that may be obtained by choosing from the set of optional features. However, the present disclosure is to be interpreted as explicitly disclosing all such combinations/permutations. For example, a system described as having three optional features may be embodied in seven different ways, namely with just one of the three possible features, with any two of the three possible features or with all three of the three possible features.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of the invention, even those disclosed solely in combination with other features of the invention, may be combined in any configuration excepting those readily apparent to the person skilled in the art as nonsensical. Likewise, use of the singular and plural is solely 10 for the sake of illustration and is not to be interpreted as limiting. Except where the contrary is explicitly noted, the plural may be replaced by the singular and vice-versa.

1. A connector comprising:
a contact support; and
an elastically deformable element, wherein
said connector defines a contact direction, and
in a deformed state, said elastically deformable element exerts a force that urges said contact support in said contact direction.

2. The connector of claim 1, comprising:
a housing, wherein
said contact support is elastically supported relative to said housing.

3. The connector of claim 1, comprising:
a housing; and
a signal transmission component, wherein
said signal transmission component is affixed to said housing, and
in an unengaged state of said connector, said signal transmission component elastically supports said contact support.

4. The connector of claim 3, wherein:
in an unengaged state of said connector, said signal transmission component supports said contact support such that said contact support abuts said elastically deformable element.

5. The connector of claim 3 or 4, wherein:
said signal transmission component is elastically affixed to said housing.

6. The connector of any one of claims 3-5, comprising:
a first contact that protrudes from said contact support, wherein
said first contact is electrically connected to a conductor of said signal transmission component, and
a protruding length of said first contact is less than a length selected from the group consisting of 5 mm, 2 mm, 1 mm, and 0.5 mm.

7. The connector of any one of claims 1-5, comprising:
a first contact that protrudes from said contact support, wherein
a protruding length of said first contact is less than a length selected from the group consisting of 5 mm, 2 mm, 1 mm, and 0.5 mm.

8. The connector of any one of claims 1-5, comprising:
a first contact that protrudes from said contact support; and
a second contact that protrudes from said contact support, wherein
said first contact is electrically insulated from said second contact, and
a distance from a central longitudinal axis of said first contact to a central longitudinal axis of said second contact is less than a distance selected from the group consisting of 2 mm, 1 mm, 0.5 mm, and 0.2 mm.

9. The connector of claim 8, wherein:
a protruding length of said first contact is less than a length selected from the group consisting of 5 mm, 2 mm, 1 mm, and 0.5 mm.
a protruding length of said second contact is less than a length selected from the group consisting of 5 mm, 2 mm, 1 mm, and 0.5 mm.

10. An assembly comprising:
a connector; and
a device, wherein
said device comprises:
a planar surface comprising a contact region.
said connector comprises:
a contact support;
an elastically deformable element; and
a first contact that protrudes from said contact support, wherein
said connector defines a contact direction, and
in a deformed state, said elastically deformable element exerts a force that urges said contact support in said contact direction, and
said first contact abuts said contact region.

11. The assembly of claim 10, comprising:
a housing, wherein
said contact support is elastically supported relative to said housing.

12. The assembly of claim 10 or 11, wherein:
a protruding length of said first contact is less than a length selected from the group consisting of 5 mm, 2 mm, 1 mm, and 0.5 mm.

13. The assembly of any one of claims 10-12, wherein:
said connector comprises a second contact that protrudes from said contact support,
said first contact is electrically insulated from said second contact, and
a distance from a central longitudinal axis of said first contact to a central longitudinal axis of said second contact is less than a distance selected from the group consisting of 2 mm, 1 mm, 0.5 mm, and 0.2 mm.

14. A connector comprising:
a housing;
a contact support; and
an elastically deformable element, wherein
said connector defines a reference plane,
when said contact support is in a first position, said contact support intersects said reference plane, and
said elastically deformable element inhibits a movement of said contact support from said first position.

15. The connector of claim 14, comprising:
a signal transmission component, wherein
said signal transmission component is affixed to said housing, and
in an unengaged state of said connector, said signal transmission component elastically supports said contact support.

16. The connector of claim 15, wherein:
in an unengaged state of said connector, said signal transmission component supports said contact support such that said contact support abuts said elastically deformable element.

17. The connector of any one of claims 14-16, wherein:
said contact support comprises an alignment structure,
when said contact support is in a second position, said alignment structure is aligned with said reference plane, and
a movement of said contact support into said second position effects an elastic deformation of said elastically deformable element.

18. An assembly comprising:
a connector; and
a device, wherein
said device comprises:
a planar surface comprising a contact region.
said connector comprises:
a housing;
a contact support;
a first contact that protrudes from said contact support; and
an elastically deformable element,
said connector defines a reference plane,
when said contact support is in a first position, said contact support intersects said reference plane,
said elastically deformable element inhibits a movement of said contact support from said first position, and
said connector is connected to said device such that said reference plane is coplanar with said planar surface, and such that said first contact abuts said contact region.

19. The assembly of claim 18, wherein:
said contact support is elastically supported relative to said housing.

20. The assembly of claim 18 or 19, wherein:
said contact support comprises an alignment structure,
when said contact support is in a second position, said alignment structure is aligned with said reference plane, and
a movement of said contact support into said second position effects an elastic deformation of said elastically deformable element.
